(19) United States
(12) Patent Application Publication
(10) Pub. No.: US 2020/0110346 A1
(43) Pub. Date: Apr. 9, 2020

(54) METHOD TO MAKE A MULTILAYERED CRYSTALLINE POLYESTER TONER PARTICLE USING A DUAL EMULSION AGGREGATION PROCESS

(71) Applicant: LEXMARK INTERNATIONAL, INC., LEXINGTON, KY (US)

(72) Inventors: JING X. SUN, LEXINGTON, KY (US); CORY NATHAN HAMMOND, WINCHESTER, KY (US); AARON MICHAEL DAHLKE, LEXINGTON, KY (US)

(21) Appl. No.: 16/152,714

(22) Filed: Oct. 5, 2018

(51) Int. Cl. G03G 9/08; G03G 9/087

(52) U.S. Cl. CPC G03G 9/0804; G03G 9/08755

(57) ABSTRACT

A method to make a chemically prepared crystalline polyester toner for use in electrophotography and more particularly to a method to make a multilayered crystalline polyester toner particle using a dual emulsion aggregation process. The dual emulsion aggregation process includes a first agglomeration step using an acid and a second agglomeration step using a soluble alkaline earth metal salt solution.

### CROSS REFERENCES TO RELATED APPLICATIONS

This patent application is related to U.S. patent application Ser. No. 15/941,203 filed Mar. 30, 2018, entitled “Multilayered Toner Particle Having a Borax Coupling Agent and Method of Preparing the Same”, and assigned to the assignee of the present application.

### FIELD OF THE DISCLOSURE

The present invention relates to a method to make a chemically prepared crystalline polyester toner for use in electrophotography and more particularly to a method to make a multilayered crystalline polyester toner particle using a dual emulsion aggregation process. The dual emulsion aggregation process includes a first agglomeration step using an acid and a second agglomeration step using a soluble alkaline earth metal salt solution.

### DESCRIPTION OF THE RELATED ART

Toners for use in electrophotographic printers include two primary types, mechanically milled toners and chemically prepared toners (CPT). Chemically prepared toners have significant advantages over mechanically milled toners including better print quality, higher toner transfer efficiency and lower torque properties for various components of the electrophotographic printer such as a developer roller, a fuser belt and a charge roller. The particle size distribution of CPTs is typically narrower than the particle size distribution of mechanically milled toners. The size and shape of CPTs are also easier to control than mechanically milled toners.

One process for preparing a CPT is by emulsion aggregation. Emulsion aggregation is a process carried out in an aqueous system resulting in good control of both the size and shape of the toner particles. The toner components typically include a polymer binder, one or more colorants and a release agent. The disclosed multilayered toner particle having a borax coupling agent is prepared using an emulsion aggregation process.

One important characteristic of any toner is its fuse window. The fuse window is the range of temperatures at which fusing is satisfactorily conducted without incomplete fusion and without transfer of toner to the heating element, which may be a roller, belt or other member contacting the toner during fusing. Thus, below the low end of the fuse window the toner is incompletely melted and above the high end of the fuse window the toner flows onto the fixing member where it mars subsequent sheets being fixed. It is preferred that the low end of the fuse window be as low as possible to reduce the required temperature of the fuser in the electrophotographic printer to therefore improve the printer's safety and to conserve energy.

In addition to fuse at an energy saving low temperature, the toner must also be able to survive the temperature and humidity extremes associated with storage and shipping—commonly called the ship/store test. Caking or blocking of the toner during shipping and storage usually results in print flaws. Energy saving low fusing toner is desirable but the low end of the fuse window cannot be so low that the toner melts during the storing or shipping of a toner cartridge containing the toner. A low melt and low energy fusing toner must be robust enough to endure shipping and storage conditions to be attractive in a worldwide market.

Toners formed from polyester binder resins typically possess better mechanical properties than toners formed from a styrene-acrylic copolymer binder of similar melt viscosity characteristics. Polyester toners also have better compatibility with color pigments resulting in a wider color gamut. However, while polyester toners produced through emulsion aggregation possess excellent fusibility, issues related to the migration of lower molecular weight resins, waxes and colorants persist. The migration of these ingredients to the surface of the toner particle weakens the toner's fusing, toner color covering power, emission of ultrafine particles during fusing, and ship store properties. Hence, an emulsion aggregation process to make a toner that reduces the migration of lower molecular weight resins, waxes and colorants to the toner particle surface is desired.

To reach efficient energy fusing and minimize the ultrafine particle emission during fusing, the fusing window of a chemically processed toner is preferred to be about 170° C. or lower, therefore, using crystalline polyester would be a promising option to reach this temperature range. It is also important the individual components found in a toner particle such as the pigment, wax and the polymer (such as a polyester resin) need to be well defined in a specific position in toner particle to maintain the above-described ship store property of the toner. Although crystalline polyester (CPE) resins are useful to lower the fusing window, CPE resins have a low molecular weight and easily migrate when they lose their crystallinity. Once the CPE resin loses its crystallinity during the emulsion aggregation process in the circulation process, the low molecular weight property of the CPE resin unfortunately results in the migration of the CPE resin to the surface of the toner particle which destroys the ship store property of the toner.

U.S. Pat. No. 8,669,035, assigned to the assignee of the present application and incorporated by reference in their entirety, disclosed a method to make a chemically produced crystalline polyester core shell toner having a borax coupling agent between the core and the shell. The resulting crystalline core shell polyester toner did fuse at the target low fusing temperature but unfortunately did not maintain the desired ship store property. This undesirable result is caused by the CPE resin not successfully being maintained in the inner core of the of the toner particle, leading to the migration of the CPE resin to the surface of the toner during the emulsion aggregation process. To fix these ship store issues, U.S. patent application Ser. No. 15/941,203, filed Mar. 30, 2018, entitled “Multilayered Toner Particle Having a Borax Coupling Agent and Method of Preparing the Same”, and assigned to the assignee of the present application and incorporated by reference in their entirety, disclosed a single emulsion aggregation process to make a core shell toner wherein a protecting layer was placed between the core shell. This multilayered structure in the core shell toner improved the ship store property of the toner, however this multilayered structure introduced new problem. The agglomeration was not efficient due to the multilayered structure, decreasing the resin content in the core agglomeration which resulted in pigment and wax that could not be fully agglomerated, unfortunately leading to pigment outflow. What is needed is a method of making a chemically prepared crystalline polyester core shell toner which efficiently controls the distribution of each component such as the CPE resin, pigment and wax in specific positions in the core of the toner, and can simultaneously fuse at an energy saving low temperature of 170° C. or lower, survive shipping and storage conditions and not lose any pigment during the emulsion aggregation process.

The disclosed dual emulsion aggregation method to make a chemically prepared crystalline polyester toner having a multilayered structure results in the above-enumerated desirable properties. The dual emulsion aggregation method includes a first agglomeration step using an acid and a second agglomeration step using a soluble alkaline earth metal salt solution. Performing this second step in the emulsion aggregation process using a soluble alkaline earth metal salt solution surprisingly further precipitated the components in the core of the toner that escaped during the first step acid precipitation. Furthermore, the inventors have discovered that using an alkaline earth metal as the agglomerating agent as opposed to a transition metal did not crosslink the polyester resins resulting in the deterioration of the fuse window. This above described dual aggregation process produced a crystalline polyester core shell toner having a multilayered structure allowing for tighter control of the locations of toner components within the toner particle, thereby efficiently controlling properties such as low temperature fusing and ship store. Furthermore, this specific dual agglomeration emulsion aggregation process ensured that the low molecular weight resins, waxes and colorants are completely covered within the center of the toner particle and blocked the pigment loss/outflow when making the toner particle.

### SUMMARY

A dual aggregation method for producing a multilayered polyester toner for electrophotography, according to an embodiment, includes preparing a crystalline polyester emulsion, a first amorphous polyester emulsion, a second amorphous polyester emulsion, a pigment dispersion, and a wax emulsion. The first amorphous polyester emulsion is divided into a first portion and a second portion. The crystalline polyester emulsion is combined with the pigment dispersion, the wax emulsion, and the first portion of the first amorphous polyester emulsion to form toner cores. The pH of the combination of the crystalline polyester emulsion, the pigment dispersion, the wax emulsion, and the first portion of the first amorphous polyester emulsion is adjusted by the addition of an acid to promote agglomeration of the toner cores. Once the toner cores reach a predetermined size, the second portion of the first amorphous polyester emulsion is added to the toner cores followed by the second agglomeration step using a soluble alkaline earth metal salt solution. Example soluble alkaline earth metal salt solutions include magnesium, and calcium salt solutions and other possible alkaline earth metal salts solutions. After this second agglomeration step, a first layer surrounding the toner cores is formed. Once the toner cores with additional first layer reach a predetermined size, an optional borax coupling agent can be added in the emulsion aggregation process. The second amorphous polyester emulsion is then combined and agglomerated with the toner cores having the first layer surrounding the toner core to form a second layer that surrounds or is formed on the surface of the above described first layer. The second layer also acts as an outermost shell that surrounds the entire toner particle. The aggregated toner cores, first layer, optional borax coupling agent and second layer/shell are then fused to form multilayered toner particles.

### DETAILED DESCRIPTION

It is to be understood that various omissions and substitutions of equivalents are contemplated as circumstances may suggest or render expedient, but these are intended to cover the application or implementation without departing from the spirit or scope of the claims of the present disclosure. It is to be understood that the present disclosure is not limited in its application to the details of components set forth in the following description. The present disclosure is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the terms “a” and “an” herein do not denote a limitation of quantity, but rather denote the presence of at least one of the referenced item.

The present invention relates to a method to make a chemically prepared toner for use in electrophotography and more particularly to a method to make a multilayered crystalline polyester core shell toner using a dual emulsion aggregation process. The dual emulsion aggregation process includes a first agglomeration step using an acid and a second agglomeration step using an alkaline earth metal salt solution. The dual agglomeration method using an acid agglomeration step followed by an alkali earth metal salt solution agglomeration step allows for a better distribution of the toner components, such as wax domains and pigment and crystalline polyester away from the surface of the toner. This allocation of the toner components in the core allows the toner to fuse at an energy saving temperature of 170° C. or lower while simultaneously having acceptable ship store properties and minimal pigment outflow.

The toner is utilized in an electrophotographic printer such as a printer, copier, multi-function device or an all-in-one device. The toner may be provided in a cartridge that supplies toner to the electrophotographic printer. Example methods of forming toner using emulsion aggregation techniques are found in U.S. Pat. Nos. 6,531,254 and 6,531,256, which are incorporated by reference herein in their entirety. Additionally, U.S. Pat. Nos. 8,669,035; 9,023,569; 9,612,545 and 9,671,709 disclose example toner formulations and methods of making toner using a borax coupling agent and are assigned to the applicants of the present invention and are incorporated by reference herein in their entirety.

In the present emulsion aggregation process, the toner particles are manufactured by chemical methods as opposed to physical methods such as pulverization. Generally, the multilayered toner particles include one or more polymer binders, a release agent or wax, a colorant, a borax coupling agent and one or more optional additives such as a charge control agent (CCA). In an embodiment, three different polymer latexes are used. The first polymer latex is a crystalline polyester. The melting point of the crystalline polyester is preferred in the range from 70° C. to 100° C., more preferably about 80° C. The second polymer latex is a first amorphous polyester having a medium Tg, a medium Tm and a medium molecular weight. This first amorphous polyester latex can be divided into portions. In an embodiment, the first amorphous polyester latex is divided into a first portion and a second portion. The third polymer latex is a second amorphous polyester having a high Tg, a high Tm and a high molecular weight. Using an emulsion aggregation method, the crystalline polyester latex, the pigment, the wax and the first portion of the first amorphous polyester latex are agglomerated together to form the center core of the multilayered toner particle. The second portion of the first amorphous polyester latex is added followed by the second agglomeration step wherein a soluble alkaline earth metal salt solution is added and forms a first layer surrounding the outer surface of the toner core. An optional borax coupling agent can then be added during next step in the emulsion aggregation process. If the borax coupling agent is added at this step in the emulsion aggregation process, the borax coupling agent associates around the first layer surrounding the toner particle. In the next step of the emulsion aggregation process, the second polymer latex having a high Tg, a high Tm and a high molecular weight is added and aggregated to form a second and final shell layer around the toner core and the first layer. The aggregated toner cores, first layer and second layer/shell are then fused to form multilayered toner particles.

A detailed synthesis of the multilayered toner of the present invention is set forth as follows: Emulsions of the crystalline polyester binder and first and second amorphous polyester binders having the above-described desired Tg(s), Tm(s), and molecular weight(s) are formed in water, optionally with organic solvent, with an inorganic base such as sodium hydroxide, potassium hydroxide, ammonium hydroxide, or an organic amine compound. A stabilizing agent having an anionic functional group (A−), e.g., an anionic surfactant or an anionic polymeric dispersant may also be included. It will be appreciated that a cationic (C+) functional group, e.g., a cationic surfactant or a cationic polymeric dispersant, may be substituted as desired.

The crystalline polyester latex and first and second amorphous polyester latexes, colorant, release agent and the optional CCA are dispersed separately in their own aqueous environments or in one aqueous mixture, as desired, in the presence of a stabilizing agent having similar functionality (and ionic charge) as the stabilizing agent employed in the polyester latexes. The optional CCA may be dispersed separately in the second and outermost layer of the toner particles, if necessary.

The crystalline polyester latex, a first portion of the first amorphous polyester latex, the colorant dispersion, and the release agent dispersion are then mixed and stirred to ensure a homogenous composition. As used herein, the term dispersion refers to a system in which particles are dispersed in a continuous phase of a different composition (or state) and may include an emulsion. In the first agglomeration step, acid is added to reduce the pH and cause flocculation. In this case, flocculation includes the formation of a gel where resin, colorant, release agent and CCA form an aggregate mixture, typically from particles 1-2 microns (μm) in size. Unless stated otherwise, reference to particle size herein refers to the largest cross-sectional dimension of the particle. The aggregated toner particles may then be heated to a temperature that is less than or around (e.g., ±5° C.) the glass transition temperature (Tg) of the first amorphous polyester latex to induce the growth of clusters of the aggregate particles. Once the aggregate particles reach the desired size of the toner core, the second portion of the first amorphous polyester latex is added followed by the second agglomeration step wherein a soluble alkaline earth metal salt solution is added and forms a first layer surrounding the outer surface of the toner core. The reaction temperature is maintained until the particles reached a desired size. An optional borax coupling agent can then be added during next step in the emulsion aggregation process. If the borax coupling agent is added at this step in the emulsion aggregation process, the borax coupling agent is added so that it forms on the outer surface of the first layer, composed of the second portion of the first amorphous polyester latex. Following addition of the optional borax coupling agent (if used), the second amorphous polyester latex is then added. This second amorphous polyester latex aggregates around the toner particle having the toner core/first layer/optional borax coupling agent structure to form the second and outermost shell layer, wherein the multilayered toner particle is formed. Once the aggregate particles reach the desired toner size, base may be added to increase the pH and reionize the anionic stabilizing agent to prevent further particle growth or one can add additional anionic stabilizing agents. The temperature is then raised above the glass transition temperature of the amorphous polyester latexes to fuse the particles together within each cluster. This temperature is maintained until the particles reach the desired circularity.

The multilayered toner particles produced have an average particle size of between about 3 μm and about 20 μm (number average particle size) including all values and increments therebetween, such as between about 4 μm and about 9 μm or, more particularly, between about 5 μm and about 7 μm. The multilayered toner particles produced have an average degree of circularity between about 0.90 and about 1.00, including all values and increments therebetween, such as about 0.93 to about 0.98. The average degree of circularity and average particle size may be determined by a Sysmex Flow Particle Image Analyzer (e.g., FPIA-3000) available from Malvern Instruments, Ltd., Malvern, Worcestershire, UK.

The ratio of the crystalline polyester binder, first and second amorphous polyester binders forming the core and the first and second shell layer may be varied. The ratio of the polyester in the core:polyester in first layer:polyester in second layer can range from 18:47:35 to 41.5:23.5:35 by wt. In an embodiment, the first and second portions of the first amorphous polyester binder are approximately equal, having a ratio of 50:50. The ratio of the first portion of the first amorphous polyester binder to the second portion of the first polyester binder can range from 0:1 to 3:1. In an embodiment, the high Tg/high Tm second polyester may be between about 20% to about 35% by weight of the total amount of polyesters used in the multilayered toner formulation.

Through this multilayered structure and dual emulsion aggregation process using an acid and a soluble alkaline earth metal salt solution, the position of the components of the toner, such as the wax, pigment and CPE resin may be specifically controlled in specific locations in the core of the toner particle, thereby efficiently controlling toner properties such as fusing, charging, ship store, and loss of pigment. More specifically, having the CPE resin (which is used to promote desirable low temperature fusing but unfortunately deteriorates the ship/store), the pigment and the wax (which may affect the toner color covering power, charging, filming and fusing properties of the toner) completely covered by a first layer and a second shell layer improves the color, ship/store and low temperature fusing properties of the toner.

The various components needed to prepare the above referenced toner via the dual emulsion aggregation method will be described below. It should be noted that the various features of the indicated components may all be adjusted to facilitate the step of aggregation and formation of toner particles of desired size and geometry. It may therefore be appreciated that by controlling the indicated characteristics, one may first form relatively stable dispersions, wherein aggregation may proceed along with relatively easy control of final toner particle size for use in an electrophotographic printer or printer cartridge.

### Polymer Binder

As mentioned above, the toners herein include one or more polymer binders. The terms resin and polymer are used interchangeably herein as there is no technical difference between the two. In one embodiment, the polymer binder(s) include polyesters.

The polyester binder(s) may include a semi-crystalline polyester binder, a crystalline polyester binder or an amorphous polyester binder. The polyester binder(s) may be formed using acid monomers such as terephthalic acid, trimellitic anhydride, dodecenyl succinic anhydride, dodecyl sunninic ahhydride, sebacic acid, and fumaric acid. Further, the polyester binder(s) may be formed using alcohol monomers such as ethoxylated and propoxylated bisphenol A, 1,6-hecanediol, 1,8-octanediol, 1,10-decanediol and 1,12-dodecanediol. Example amorphous polyester resins include, but are not limited to, T100, TF-104, NE-1582, NE-701, NE-2141, NE-1569, Binder C, FPESL-2, W-85N, TL-17, TPESL-10, TPESL-11 polyester resins from Kao Corporation, Bunka Sumida-ku, Tokyo, Japan, or mixtures thereof. Various commercially available crystalline polyester resin emulsions are available from Kao Corporation, Bunka Sumida-ku, Tokyo, Japan and Reichhold Chemical Company, Durham, N.C. under the trade names EPC 2-20, EPC 3-20, 6-20, 7-20, CPES B1, EPC 8-20, EPC 9-20, EPC-10-20, CPES B20, CPES B25 and EM192692.

In the present invention, three different types of polyester resins used as the polymer binder in the multilayered toner particle. In an embodiment, a crystalline polyester resin and an amorphous polyester resin are used in the core while a different amorphous polyester binder is used for the shell. In an embodiment, the first amorphous polyester resin used in the core of the toner may be linear or slightly crosslinked and has a medium Tg of between about 55° C. and about 60° C., and a medium Tm of between about 100° C. and about 120° C. The second amorphous polyester resin used for the outermost layer/shell has high Tg/Tm. This second polyester resin has a Tg of between about 60° C. and about 65° C. and a Tm of about 110° C. and about 140° C. The melting point crystalline polyester is in the range of 70° C. to 100° C., preferably about 80° C.

### Reversible Borax Coupling Agent

The optional coupling agent used herein is borax (also known as sodium borate, sodium tetraborate, or disodium tetraborate). As used herein, the term borax coupling agent refers to a chemical compound having the complexing ability to form hydrogen bonding between polymers to bind more components together. As used herein, the term borax coupling agent is defined as enabling the formation of hydrogen bonding between polymer chains. The present multilayered toner particle has a center core surrounded by a first layer and an outermost second or shell layer. The borax coupling agent, if used, is placed between the first and second layers. This borax coupling agent assists in the anchoring or binding of the third polymer, which is found in the second or outermost shell layer, onto the surface of the first layer containing the second polymer which is surrounding the toner core. The borax coupling agent thereby helps to couple the outer shell/second layer to the outer surface of the first layer surrounding the toner core. Typically, coupling agents have multivalent bonding ability. Borax differs from commonly used permanent coupling agents, such as multivalent metal ions (e.g., aluminum and zinc), in that its bonding is reversible based on the temperature and pressure. In the electrophotographic process, it is preferable that the toner has a low fusing temperature to save energy and a low melt viscosity (“soft”) to permit high speed printing at low fusing temperatures. However, to maintain the stability of the toner during shipping and storage and to prevent filming of the printer components, toner is preferred to be “harder” at temperatures below the fusing temperature. Borax provides cross-linking through hydrogen bonding between its hydroxyl groups and the functional groups found in the polymers that it is bonded thereto. The hydrogen bonding is sensitive to temperature and pressure and is not a stable and permanent bond. For example, when the temperature is increased to a certain degree, or stress is applied to the polymer, the bond will partially or completely break causing the polymer to “flow” or tear off. The reversibility of the bonds formed by the borax coupling agent is particularly useful in toner because it permits a “soft” toner at the fusing temperature but a “hard” toner at the storage temperature.

The quantity of the borax coupling agent used herein can be varied. The borax coupling agent may be provided at between about 0.1% and about 0.5% by weight of the total polymer binder in the toner, including all values and increments between, such as between 0.1% and about 1.0% or between 0.1% and about 0.5%. If too much coupling agent is used, its bonding may not be completely broken during high temperature fusing and will affect the agglomeration and particle size. On the other hand, if too little coupling agent is used, it may fail to provide the desired bonding and buffering effects.

### Colorant

Colorants are compositions that impart color or other visual effects to the toner and may include carbon black, dyes (which may be soluble in a given medium and capable of precipitation), pigments (which may be insoluble in a given medium) or a combination of the two. A colorant dispersion may be prepared by mixing the pigment in water with a dispersant. Alternatively, a self-dispersing colorant may be used thereby permitting omission of the dispersant. The colorant may be present in the dispersion at a level of about 5% to about 40% by weight including all values and increments therebetween. For example, the colorant may be present in the dispersion at a level of about 10% to about 30% by weight. The dispersion of colorant may contain particles at a size of about 50 nanometers (nm) to about 500 nm including all values and increments therebetween. Further, the colorant dispersion may have a pigment weight percent divided by dispersant weight percent (P/D ratio) of about 1:1 to about 8:1 including all values and increments therebetween, such as about 2:1 to about 5:1. The colorant may be present at less than or equal to about 30% by weight of the final toner formulation including all values and increments therebetween.

### Release Agent

The release agent used may include any compound that facilitates the release of toner from a component in an electrophotographic printer (e.g., release from a roller surface). For example, the release agent or wax may include polyolefin wax, Fischer-Tropsch wax, ester wax, polyester wax, polyethylene wax, metal salts of fatty acids, fatty acid esters, partially saponified fatty acid esters, higher fatty acid esters, higher alcohols, paraffin wax, carnauba wax, amide waxes and polyhydric alcohol esters or mixtures thereof.

The wax or release agent may therefore include a low molecular weight hydrocarbon based polymer (e.g., Mn≤10,000) having a melting point of less than about 140° C. including all values and increments between about 50° C. and about 140° C. The wax may be present in the dispersion at an amount of about 5% to about 35% by weight including all values and increments there between. For example, the wax may be present in the dispersion at an amount of about 10% to about 18% by weight. The wax dispersion may also contain particles at a size of about 50 nm to about 1 μm including all values and increments there between. In addition, the wax dispersion may be further characterized as having a wax weight percent divided by dispersant weight percent (RA/D ratio) of about 1:1 to about 30:1. For example, the RA/D ratio may be about 3:1 to about 8:1. The wax is provided in the range of about 2% to about 40% by weight of the final toner formulation including all values and increments there between. Exemplary waxes having these above enumerated characteristics include, but are not limited to, SD-A01, SD-B01, MPA-A02, CM-A01 and CM-B01 from Cytech Products, Inc., Polywax M70, Polywax M80 and Polywax 500 from Baker Petrolite and WE5 from Nippon Oil and Fat.

### Surfactant/Dispersant

A surfactant, a polymeric dispersant or a combination thereof may be used. The polymeric dispersant may generally include three components, namely, a hydrophilic component, a hydrophobic component and a protective colloid component. Reference to hydrophobic refers to a relatively non-polar type chemical structure that tends to self-associate in the presence of water. The hydrophobic component of the polymeric dispersant may include electron-rich functional groups or long chain hydrocarbons. Such functional groups are known to exhibit strong interaction and/or adsorption properties with respect to particle surfaces such as the colorant and the polyester binder resin of the polyester resin emulsion. Hydrophilic functionality refers to relatively polar functionality (e.g., an anionic group) which may then tend to associate with water molecules. The protective colloid component includes a water soluble group with no ionic function. The protective colloid component of the polymeric dispersant provides extra stability in addition to the hydrophilic component in an aqueous system. Use of the protective colloid component substantially reduces the amount of the ionic monomer segment or the hydrophilic component in the polymeric dispersant. Further, the protective colloid component stabilizes the polymeric dispersant in lower acidic media. The protective colloid component generally includes polyethylene glycol (PEG) groups. The dispersant employed herein may include the dispersants disclosed in U.S. Pat. Nos. 6,991,884 and 5,714,538, which are assigned to the assignee of the present application and are incorporated by reference herein in their entirety.

The surfactant, as used herein, may be a conventional surfactant known in the art for dispersing non self-dispersing colorants and release agents employed for preparing toner formulations for electrophotography. Commercial surfactants such as the AKYPO series of carboxylic acids from AKYPO from Kao Corporation, Bunka Sumida-ku, Tokyo, Japan may be used. For example, alkyl ether carboxylates and alkyl ether sulfates, preferably lauryl ether carboxylates and lauryl ether sulfates, respectively, may be used. One particular suitable anionic surfactant is AKYPO RLM-100 available from Kao Corporation, Bunka Sumida-ku, Tokyo, Japan, which is laureth-11 carboxylic acid thereby providing anionic carboxylate functionality. Other anionic surfactants contemplated herein include alkyl phosphates, alkyl sulfonates and alkyl benzene sulfonates. Sulfonic acid containing polymers or surfactants may also be employed.

### Optional Additives

The toner formulation of the present disclosure may also include one or more conventional charge control agents, which may optionally be used for preparing the toner formulation. A charge control agent may be understood as a compound that assists in the production and stability of a tribocharge in the toner. The charge control agent(s) also help in preventing deterioration of charge properties of the toner formulation. The charge control agent(s) may be prepared in the form of a dispersion in a manner similar to that of the colorant and release agent dispersions discussed above.

The toner formulation may include one or more additional additives, such as acids and/or bases, emulsifiers, extra particular additives, UV absorbers, fluorescent additives, pearlescent additives, plasticizers and combinations thereof. These additives may be desired to enhance the properties of an image printed using the present toner formulation. For example, UV absorbers may be included to increase UV light fade resistance by preventing gradual fading of the image upon subsequent exposures to ultraviolet radiations. Suitable examples of the UV absorbers include, but are not limited to, benzophenone, benzotriazole, acetanilide, triazine and derivatives thereof.

The following examples are provided to further illustrate the teachings of the present disclosure, not to limit the scope of the present disclosure.

### Example Polyester Resin Emulsions

Preparation of Example Polyester Resin Emulsion A Having a Medium Tg and Medium Tm (‘Polyester Resin Emulsion A’)

A polyester resin having a peak molecular weight of about 11,000, a glass transition temperature (Tg) of about 55° C. to about 58° C., a melt temperature (Tm) of about 115° C., and an acid value of about 8 to about 13 was used. The glass transition temperature is measured by differential scanning calorimetry (DSC), wherein, in this case, the onset of the shift in baseline (heat capacity) thereby indicates that the Tg may occur at about 55° C. to about 58° C. at a heating rate of about 5° C. per minute. The acid value may be due to the presence of one or more free carboxylic acid functionalities (—COOH) in the polyester. Acid value refers to the mass of potassium hydroxide (KOH) in milligrams that is required to neutralize one gram of the polyester. The acid value is therefore a measure of the amount of carboxylic acid groups in the polyester.

150 g of the polyester resin was dissolved in 450 g of methyl ethyl ketone (MEK) in a round bottom flask with stirring. The dissolved resin was then poured into a beaker. The beaker was placed in an ice bath directly under a homogenizer. The homogenizer was turned on at high shear and 3.7 g of 10% potassium hydroxide (KOH) solution and 500 g of de-ionized water were immediately added to the beaker. The homogenizer was run at high shear for about 2-4 minutes then the homogenized resin solution was placed in a vacuum distillation reactor. The reactor temperature was maintained at about 43° C. and the pressure was maintained between about 22 inHg and about 23 inHg. About 500 mL of additional de-ionized water was added to the reactor and the temperature was gradually increased to about 70° C. to ensure that substantially all of the MEK was distilled out. The heat to the reactor was then turned off and the mixture was stirred until it reached room temperature. Once the reactor reached room temperature, the vacuum was turned off and the resin solution was removed and placed in storage bottles.

The particle size of Polyester Resin Emulsion A was between about 190 nm and about 240 nm (volume average) as measured by a Nanotrac Particle Size Analyzer. The pH of the resin solution was between about 7.5 and about 8.2.

Preparation of Example Polyester Resin Emulsion B Having a Low Tg and a Low Tm (‘Polyester Resin Emulsion B’)

A polyester resin having a peak molecular weight of about 6500, a glass transition temperature of about 49° C. to about 54° C., a melt temperature of about 95° C., and an acid value of about 21 to about 24 was used to form an emulsion using the procedure outlined making Polyester Resin Emulsion A except using about 12.8 g of the 10% potassium hydroxide (KOH) solution.

The particle size of Polyester Resin Emulsion B was between about 160 nm and about 220 nm (volume average) as measured by a Nanotrac Particle Size Analyzer. The pH of the resin solution was between about 6.3 and about 6.8.

Preparation of Example Polyester Resin Emulsion C Having a High Tg and a High Tm (‘Polyester Resin Emulsion C’)

A polyester resin having a peak molecular weight of about 13,000, a glass transition temperature of about 58° C. to about 62° C., a melt temperature of about 110° C. and an acid value of about 20 to 23 was used to form an emulsion using the procedure outlined making Polyester Resin Emulsion A except using about 10 g of the 10% potassium hydroxide (KOH) solution.

The particle size of Polyester Resin Emulsion C was between about 190 nm and about 240 nm (volume average) as measured by a Nanotrac Particle Size Analyzer. The pH of the resin solution was between about 6.5 and about 7.0.

Preparation of Example Crystalline Polyester Resin Emulsion

A crystalline polyester resin having a melting temperature of about 82° C., and an acid value of about 15 to about 18 was used to form an emulsion.

125 g of the crystalline polyester resin was dissolved in 375 g of tetrahydrofuran (THF) in a round bottom flask with heat and stirring. The dissolved resin was then poured into a beaker. The beaker was placed under a homogenizer. The homogenizer was turned on at high shear and 17 g of 10% potassium hydroxide (KOH) solution and 400 g of de-ionized water were immediately added to the beaker. The homogenizer was run at high shear for about 2-4 minutes then the homogenized resin solution was placed in a vacuum distillation reactor. The reactor temperature was maintained at about 43° C. and the pressure was maintained between about 22 inHg and about 23 inHg. About 500 mL of additional de-ionized water was added to the reactor and the temperature was gradually increased to about 60° C. to ensure that substantially all of the THF was distilled out. The heat to the reactor was then turned off and the mixture was stirred until it reached room temperature. Once the reactor reached room temperature, the vacuum was turned off and the resin solution was removed and placed in storage bottles.

The particle size of the crystalline polyester resin emulsion was between about 185 nm and about 235 nm (volume average) as measured by a NANOTRAC Particle Size Analyzer. The pH of the resin solution was about 8.6.

Preparation of Example Cyan Pigment Dispersion

About 10 g of AKYPO RLM-100 polyoxyethylene(10) lauryl ether carboxylic acid from Kao Corporation, Bunka Sumida-ku, Tokyo, Japan was combined with about 350 g of de-ionized water and the pH was adjusted to ˜7-9 using sodium hydroxide. About 10 g of Solsperse 27000 from Lubrizol Advanced Materials, Cleveland, Ohio, USA was added and the dispersant and water mixture was blended with an electrical stirrer followed by the relatively slow addition of 100 g of pigment blue 15:3. Once the pigment was completely wetted and dispersed, the mixture was added to a horizontal media mill to reduce the particle size. The solution was processed in the media mill until the particle size was about 200 nm. The final pigment dispersion was set to contain about 20% to about 40% solids by weight.

Preparation of Example Wax Emulsion

About 12 g of AKYPO RLM-100 polyoxyethylene(10) lauryl ether carboxylic acid from Kao Corporation, Bunka Sumida-ku, Tokyo, Japan was combined with about 325 g of de-ionized water and the pH was adjusted to ˜7-9 using sodium hydroxide. The mixture was then processed through a microfluidizer and heated to about 90° C. About 60 g of ester/paraffin wax from Cytec Products Inc., Elizabethtown, Ky. was added to the hot mixture while the temperature was maintained at about 90° C. for about 15 minutes. The emulsion was then removed from the microfluidizer when the particle size was below about 300 nm. The solution was then stirred at room temperature. The wax emulsion was set to contain about 10% to about 40% solids by weight.

### Toner Formulation Examples

Toner 1

Toner 1 is Xerox® EA-Eco toner. EA-Eco is produced using an emulsion aggregation process with crystalline polyester.

Toner 2—Single Aggregation Non-Multilayered Crystalline Polyester Toner

Components were added to a 2 L reactor in the following amounts: about 449 g of 30.16% wt. Polyester Resin Emulsion A, 113.9 g of Crystalline Polyester Resin Emulsion with 21.6% wt solid, 53.8 g Cyan Pigment Dispersion (with 30.3% wt. solid and 5:1 pigment-to-dispersant ratio), 100 g of 34.23% Wax Emulsion with wax-to-dispersant ratio of about 28.5:1, and 850 g of deionized water.

The mixture was heated in the reactor to 25° C. and a circulation loop was started consisting of a high shear mixer and an acid addition pump. The mixture was sent through the loop and the high shear mixer was set at 10,000 rpm. Acid was slowly added to the high shear mixer to evenly disperse the acid in the toner mixture so that there were no pockets of low pH. Acid addition took about 4 minutes with 210 g of 1% sulfuric acid solution. The flow of the loop was then reversed to return the toner mixture to the reactor and the temperature of the reactor was increased to about 40-45° C. Once the particle size reached 4.5 to 5.0 μm (number average), 5% borax solution (20 g of solution having 1.0 g borax) was added. After the addition of borax, 290.7 g of Polyester Resin Emulsion C with 29.70% wt. solid was added to form the shell layer. The mixture was stirred for about 5 minutes and the pH was monitored. Slowly heat the mixture to about 45° C. Once the particle size reached 5.5 μm (number average), 4% NaOH was added to raise the pH to about 6.8 to stop the particle growth. The reaction temperature was held for one hour. The particle size was monitored during this time. Once particle growth stopped, the temperature was increased to 83° C. to cause the particles to coalesce. This temperature was maintained until the particles reached their desired circularity (about 0.97-0.98). The toner was then washed and dried.

The toner had a number average particle size of 5.17 μm. Fines (<2 μm) were present at 1.87% (by number) and the toner possessed a circularity of 0.971, both measured by the SYSMEX FPIA-3000 particle characterization analyzer, manufactured by Malvern Instruments, Ltd., Malvern, Worchester UK. The ship/store test score registered 66 at 52° C.

Toner 3—Single Aggregation Multilayered Polyester Toner

Components were added to a 2 L reactor in the following percentages based on total solids of the emulsions: about 195 g of 29.76% Polyester Resin Emulsion A, 152 g of 29.75% Polyester Resin Emulsion B, 58.3 of Cyan Pigment Dispersion with 30.3% solids and 5:1 P:D ratio, 102.2 g of 34% Wax Emulsion with W:D ratio of about 28.5:1 (Cytech Products, Inc.), and 834 g of deionized water.

The core raw materials were stirred in the reactor at about 25° C. and a circulation loop was started consisting of a high shear mixer and an acid addition pump. The mixture was sent through the loop, with the high shear mixer set at 10,000 RPM. Acid was slowly added to the slurry passing through the high shear mixer in order to evenly disperse the acid throughout the toner mixture so that there were no pockets with a low pH. Acid addition took about four minutes with 205 g sulfuric acid. The sulfuric acid used during this step was diluted to 1% concentration before addition. The flow of the loop was then reversed to return the toner mixture to the reactor and the temperature of the reactor was increased to about 38° C. Once the particle size reached 3.5-4.0 μm (number average), 195 g of 29.76% Polyester Resin Emulsion A was added to the reactor to form the second layer around the core. Once the reaction temperature reached 42° C. and the particle sized reached about 4.0-4.5 μm (number average), 29 g of 5% borax solution was added. After the addition of borax, 290 g of 29.68% Polyester Resin Emulsion C was added. The mixture was stirred for about 5 minutes and the pH was monitored. The mixture was then slowly heated to about 50° C. Once the particle size reached 5-5.5 μm (number average), 4% NaOH was added in order to raise the pH to about 6.5 and stop particle growth. The temperature was then increased to 83° C. to cause the particles to coalesce. The temperature was maintained until the particles reached the desired circularity (above 0.97, measured on a Sysmex FPIA-3000 from Malvern). The toner was then washed and dried. Finishing agents were added so that the toner could be printed. The toner had a number average particle size 5.2 μm. Fines (<2 μm) were present at 0.85% (by number) and the toner possessed a circularity of 0.97. The ship/store score registered 48 at 52° C.

Toner 4—Single Aggregation Multilayered Polyester Toner

The toner followed the same procedure outlined in Toner 3. The resulting toner had a number average particle size 4.7 μm. Fines (<2 μm) were present at 1.39% (by number) and the toner possessed a circularity of 0.97. The ship/store score registered 51 at 52° C.

Toner 5—Dual Aggregation Multilayered Crystalline Polyester Toner (5% CPE)

Components were added to a 2 L reactor in the following amounts: about 57 g of Crystalline Polyester Resin Emulsion with 21.6% wt solid, 250 g of 29.76% wt Example Polyester Resin Emulsion A, 59.3 g of Cyan Pigment Dispersion (with 30% wt solid and 5:1 pigment-to-dispersant ratio), 102 g of the 34.0% Example Wax Emulsion with wax-to-dispersant ratio of about 28.5:1, and 750 g of the deionized water.

The mixture was mixed in the reactor at about 25° C. and a circulation loop was started consisting of a high shear mixer and an acid addition pump. The mixture was sent through the loop and the high shear mixer was set at 10,000 rpm. Acid was slowly added to the high shear mixer to evenly disperse the acid in the toner mixture so that there were no pockets of low pH. Acid addition took about 4 minutes with 150 g of 1% sulfuric acid solution. The flow of the loop was then reversed to return the toner mixture to the reactor and the temperature of the reactor was increased to about 40° C. Once the particle size reached 4.0 μm (number average), 250 of polyester resin emulsion A was added followed by 10 of 2% magnesium nitrate diluted with 50 g of DI water. Once the particle size reached 4.5 um, 4% borax solution 10.7 g was added. After the addition of borax, 290 g of Example Polyester Resin Emulsion C with 29.70% wt solid was added. The mixture was stirred for about 5 minutes and the pH was monitored. Once the particle size reached 5.5 μm (number average), 4% NaOH was added to raise the pH to about 7-7.4 to stop the particle growth. The reaction temperature was held for one hour. The particle size was monitored during this time. Once particle growth stopped, the temperature was increased to 83° C. to cause the particles to coalesce. This temperature was maintained until the particles reached their desired circularity (about 0.97-0.98). The toner was then washed and dried. The toner had a number average particle size of 5.32 μm. Fines (<2 μm) were present at 2.1% (by number) and the toner possessed a circularity of 0.974. The ship/store score registered 54 at 52° C.

Toner 6—Dual Aggregation Multilayered Crystalline Polyester Toner (10% CPE) Components were added to a 2 L reactor in the following amounts: about 122 g of Crystalline Polyester Emulsion with 21.6% wt solid, 300 g of 29.76% wt Example Polyester Resin Emulsion A, 62.5 g of Cyan Pigment Dispersion (with 30% wt solid and 5:1 pigment-to-dispersant ratio), 105 g of the 34.0% Example Wax Emulsion with wax-to-dispersant ratio of about 28.5:1, and 750 g of the deionized water.

The mixture was mixed in the reactor at about 25° C. and a circulation loop was started consisting of a high shear mixer and an acid addition pump. The mixture was sent through the loop and the high shear mixer was set at 10,000 rpm. Acid was slowly added to the high shear mixer to evenly disperse the acid in the toner mixture so that there were no pockets of low pH. Acid addition took about 4 minutes with 160 g of 1% sulfuric acid solution. The flow of the loop was then reversed to return the toner mixture to the reactor and the temperature of the reactor was increased to about 40° C. Once the particle size reached 4.0 μm (number average), 184 g of polyester resin emulsion A was added followed by 12 g of 2% magnesium nitrate diluted with 42 g of DI water. Once the particle size reached 4.7 um, 4% borax solution 10.7 g was added. After the addition of borax, 309.7 g of Example Polyester Resin Emulsion C with 29.70% wt solid was added. The mixture was stirred for about 5 minutes and the pH was monitored. Once the particle size reached 5.5 μm (number average), 4% NaOH was added to raise the pH to about 7-7.4 to stop the particle growth. The reaction temperature was held for one hour. The particle size was monitored during this time. Once particle growth stopped, the temperature was increased to 83° C. to cause the particles to coalesce. This temperature was maintained until the particles reached their desired circularity (about 0.97-0.98). The toner was then washed and dried. The toner had a number average particle size of 5.39 μm. Fines (<2 μm) were present at 0.9% (by number) and the toner possessed a circularity of 0.971. The ship/store score registered 57 at 52° C.

Toner 7—Dual Aggregation Multilayered Crystalline Polyester Toner (15% CPE) Components were added to a 2 L reactor in the following amounts: about 171 g of Crystalline Polyester Emulsion with 21.6% wt solid, 249 g of 29.76% wt Example Polyester Resin Emulsion A, 59.3 g of Cyan Pigment Dispersion (with 30% wt solid and 5:1 pigment-to-dispersant ratio), 102 g of the 34.0% Example Wax Emulsion with wax-to-dispersant ratio of about 28.5:1, and 750 g of the deionized water.

The mixture was mixed in the reactor at about 25° C. and a circulation loop was started consisting of a high shear mixer and an acid addition pump. The mixture was sent through the loop and the high shear mixer was set at 10,000 rpm. Acid was slowly added to the high shear mixer to evenly disperse the acid in the toner mixture so that there were no pockets of low pH. Acid addition took about 4 minutes with 160 g of 1% sulfuric acid solution. The flow of the loop was then reversed to return the toner mixture to the reactor and the temperature of the reactor was increased to about 40° C. Once the particle size reached 4.0 μm (number average), 166 g of Polyester Resin Emulsion A was added followed by 12 g of 2% magnesium nitrate diluted with 42 g of DI water. Once the particle size reached 4.7 um, 4% borax solution 10.7 g was added. After the addition of borax, 290 g of Example Polyester Resin Emulsion C with 29.70% wt solid was added. The mixture was stirred for about 5 minutes and the pH was monitored. Once the particle size reached 5.5 μm (number average), 4% NaOH was added to raise the pH to about 7-7.4 to stop the particle growth. The reaction temperature was held for one hour. The particle size was monitored during this time. Once particle growth stopped, the temperature was increased to 83° C. to cause the particles to coalesce. This temperature was maintained until the particles reached their desired circularity (about 0.97-0.98). The toner was then washed and dried. The toner had a number average particle size of 4.98 μm. Fines (<2 μm) were present at 1.41% (by number) and the toner possessed a circularity of 0.971. The ship/store score registered 61 at 52° C.

### Test Results

A toner's fusing properties include its fuse window. The fuse window is the range of temperatures at which fusing is satisfactorily conducted without incomplete fusion and without transfer of toner to the heating element, which may be a roller, belt or other member contacting the toner during fusing. Thus, below the low end of the fuse window the toner is incompletely melted and above the high end of the fuse window the toner flows onto the fixing member where it mars subsequent sheets being fixed. It is preferred that the low end of the fuse window be as low as possible to reduce the required temperature of the fuser in the electrophotographic printer to improve the printer's safety and to conserve energy and reduce the ultrafine particles emission. Another toner property that is measured is called the Ship to Store property. Toner must be able to survive the temperature and humidity extremes associated with storage and shipping without caking or blocking which may result in print flaws. As a result, the low end of the fuse window cannot be so low that the toner could melt during the storing or shipping of a toner cartridge containing the toner.

### Fusing Results

Each toner formulation was printed (but not fused) with toner coverage of 1.1 mg/cm2 on 24# Hammermill laser paper. The unfused sheet was then passed through a fusing robot at 60 ppm with varying heater set point temperatures at 5° C. intervals. One fuse grade measurement is a scratch resistance test. For the scratch resistance test, the fused print samples were evaluated using a Taber Abrader device from TABER Industries, North Tonawanda, N.Y., USA. The printed samples were evaluated on the Taber Abrader scale from 0 to 10 (where a rating of 10 indicates the most scratch resistance). The Taber Abrader device scratches the printed samples multiple times with different forces until the toner is scratched off the sample. The point at which the toner is scratched off corresponds with a number rating between 0 and 10 on the Taber Abrader scale.

Table 1 compares the toner fusing Example toners at 1-7 number of fusing temperatures. An acceptable low fusing temperature for a chemically prepared toner is 170° C. or below. Table 1 also shows ship/store data determined at 52° C. for 48 hours. Ship/store results below 60 are preferable and the lower the caking level the better. (caking level 1 is powdery, 10 is caked).

TABLE 1

| | Scratch Test | | | | | | | | | | | Ship/Store/caking | |
|---|---|---|---|---|---|---|---|---|---|---|---|---|---|
| Fusing Temp. (° C.) | 160 | 165 | 170 | 175 | 180 | 185 | 190 | 195 | 200 | 205 | 210 | 215 | |
| Toner 1¹ | | | | CO | 2.3333 | 7.6667 | 10 | 10 | 10 | 10 | 10 | 10 | 52/1 |
| Toner 2² | CO | 9.3 | 10 | 10 | 10 | 10 | 10 | 10 | 10 | 10 | 10 | 10 | 66/3 |
| Toner 3³ | | | | CO | 7 | 10 | 10 | 10 | 10 | 10 | 10 | 10 | 48/1 |
| Toner 4⁴ | | | | CO | 5.3333 | 8.6667 | 10 | 10 | 10 | 10 | 10 | 10 | 51/1 |
| Toner 5⁵ | | | CO | 10 | 10 | 10 | 10 | 10 | 10 | 10 | 10 | 10 | 54/1 |
| Toner 6⁶ | CO | 2 | 8.55 | 10 | 10 | 10 | 10 | 10 | 10 | 10 | 10 | 10 | 57/1 |
| Toner 7⁷ | | CO | 0 | 10 | 10 | 10 | 10 | 10 | 10 | 10 | 10 | 10 | 61/1 |

¹Toner 1 - EaEco ® manufactured by Xerox ®
²Toner 2 - Single Agglomeration Non-Multilayered Crystalline Polyester Toner
³Toner 3 - Single Agglomeration Multilayered Polyester Toner
⁴Toner 4 - Single Agglomeration Multilayered Polyester Toner
⁵Toner 5 - Dual Agglomeration Multilayered Crystalline Polyester Toner (5% CPE)
⁶Toner 6 - Dual Agglomeration Multilayered Crystalline Polyester Toner (10% CPE)
⁷Toner 7 - Dual Agglomeration Multilayered Crystalline Polyester Toner (15% CPE)

As shown in Table 1, the Toners 5-7 with CPE produced using the dual aggregation process of the present invention exhibited superior ship/store values compared to Toner 2 which also contained CPE and was produced using a conventional single aggregation method. The low end of the fusing window for Toners 5-7 with CPE was lower than the low end of the fusing window for Toner 3 and 4 which had no CPE in the toner. Specifically, Toners 5-6 with 5% and 10% CPE are fused at 165° C. and 170° C., respectfully, while providing acceptable scratch resistance. Less energy is required to accomplish an acceptable fusing operation for Toners 5-7 compared to Toners 1, 3, 4. Toner 2 with CPE and a core/shell structure provided a good fusing result compared to the other toners with CPE however its ship/store value is high compared to Toners 5-7, especially its toner caking level. Overall, Toner 6 performed the best considering both the scratching and the ship/store value. As for Toner 7, although it contained more CPE in the formulation, both the fusing and shop/store value are not as good as Toner 6.

The foregoing description of several embodiments of the present disclosure has been presented for purposes of illustration. It is not intended to be exhaustive or to limit the present disclosure to the precise forms disclosed, and obviously many modifications and variations are possible in light of the above teaching. It is intended that the scope of the present disclosure be defined by the claims appended hereto.

What is claimed is:

1. A method to make a multilayered toner particle comprising the steps of:
mixing a crystalline polyester latex, a first portion of a first amorphous polyester latex, a colorant dispersion, and a release agent dispersion to form a homogeneous composition;
performing a first agglomeration step by adding an acid to the homogeneous composition to reduce the pH and cause flocculation and form an aggregate mixture of toner particles;
heating the aggregated toner particles to a temperature that is less than or equal to the glass transition temperature of the first amorphous polyester latex wherein growth of clusters of the aggregated toner particles is induced;
adding a second portion of the first amorphous polyester latex once the clusters of the aggregated toner particles reach the desired size of a toner core;
performing a second agglomeration step including the addition of a soluble alkaline earth metal salt solution wherein a toner particle having a first layer surrounding an outer surface of a toner core is formed;
combining and agglomerating a second amorphous polyester latex with the toner particles wherein a second shell layer around is formed around the toner core and the first layer;
adding a base to increase the pH once the aggregate toner particles reach a desired toner size to prevent further particle growth; and
raising the temperature above the glass transition temperature of the first amorphous polyester latex to fuse the aggregated toner particles together within each cluster wherein a multilayered toner particle is formed.

2. The method of claim 1, wherein the crystalline polyester latex contains a crystalline polyester resin having a melting temperature (Tm) of between about 70° C. and about 100° C.

3. The method of claim 1, wherein the first amorphous polyester latex contains an amorphous polyester resin having a Tg of between about 55° C. and about 60° C. and a Tm of between about 100° C. and about 120° C.

4. The method of claim 1, wherein the second amorphous polyester latex contains an amorphous polyester resin having a Tg of between about 60° C. and about 65° C. and a Tm of between about 110° C. and about 140° C.

5. The method of claim 1, wherein ratio of the first portion of the first amorphous polyester latex to the second portion of the first amorphous polyester latex emulsion can range from 0:1 to 3:1.

6. The method of claim 1, wherein the soluble alkaline earth metal salt solution includes a magnesium salt solution.

7. The method of claim 1, wherein the soluble alkaline earth metal salt solution includes a calcium salt solution.
